(19) United States
(12) Patent Application Publication
(10) Pub. No.: US 2011/0110110 A1
(43) Pub. Date: May 12, 2011

(54) MODULARLY EXPANDABLE LAMP HOLDER

(75) Inventors: ZHENG-JAY HUANG, Chu-Nan (TW); YU-PIN LIU, Chu-Nan (TW)

(73) Assignee: FOXSEMICON INTEGRATED TECHNOLOGY, INC., Chu-Nan (TW)

(21) Appl. No.: 12/790,858

(22) Filed: May 31, 2010

(30) Foreign Application Priority Data
Nov. 11, 2009 (CN) 200910309527.1

(51) Int. Cl. F21S 8/08

(52) U.S. Cl. 362/410

(57) ABSTRACT

A modularly expandable lamp holder comprises first and second assembling surfaces. The first assembling surface has an elongated protrusion formed thereon, which includes a first portion adjacent to the first assembling surface and a second portion remote from the first assembling surface and having a size larger than that of the first portion. The second assembling surface defines an elongated groove therein, which has a configuration matching that of the protrusion. The lamp holder can be mechanically assembled with another lamp holder of this kind by the engagement of the protrusion of the lamp holder and the groove of another lamp holder.

### BACKGROUND

1. Technical Field

The present disclosure generally relates to lamp holders, and particularly, to a lamp holder capable of being assembled with other lamp holders of this kind to be a lamp holder module.

2. Description of Related Art

In the design of a lamp, light field and intensity are always major concerns. As such, light sources usually have different sizes to satisfy different particular requirements, and lamp holders should be designed with different sizes so that they can accommodate the light sources of different sizes. However, producing lamp holders having various sizes according to different requirements leads to high production and inventory cost.

Therefore, what is needed is a lamp holder that overcomes the described limitations.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views, and all the views are schematic.

FIG. 1 is an isometric view of a lamp holder of the present disclosure.

FIG. 2 is an isometric view of the lamp holder of FIG. 1 viewed from another angle.

FIG. 3 is an isometric view of a lamp holder module consisting of the lamp holder of FIG. 1 assembled with another lamp holder in accordance with the present disclosure.

### DETAILED DESCRIPTION

Reference will now be made to the drawings to describe the present modularly expandable lamp holder, in detail.

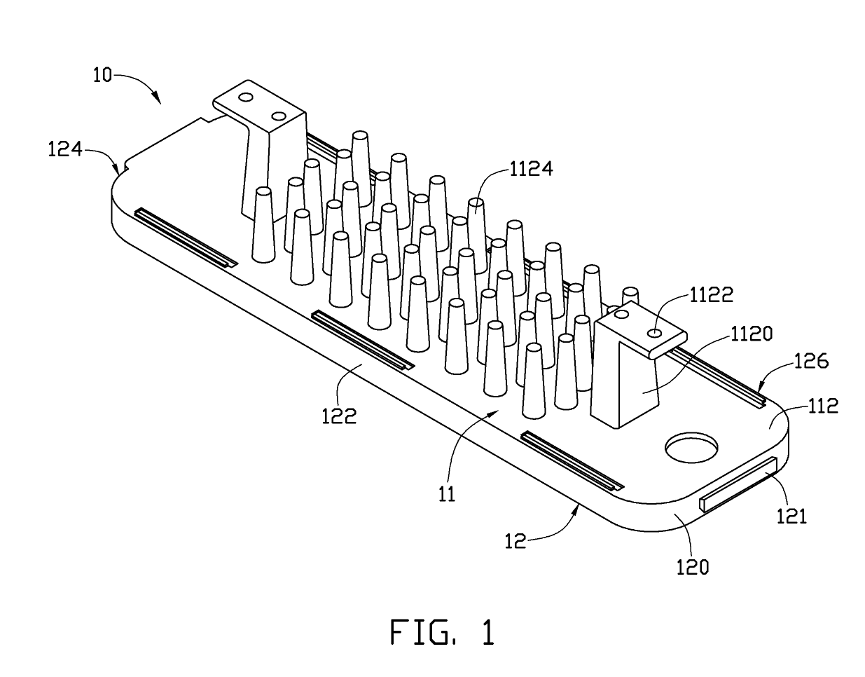

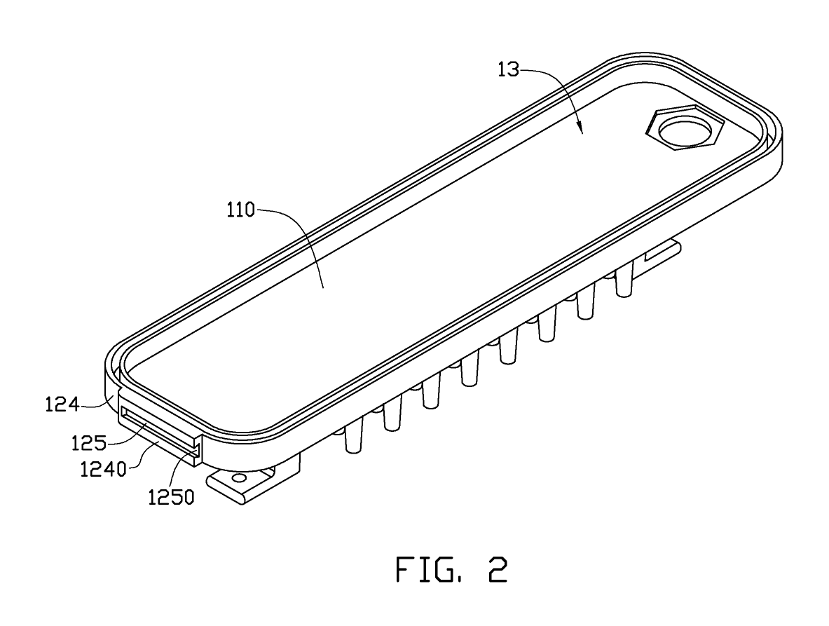

Referring to FIG. 1 and FIG. 2, a modularly expandable lamp holder 10 includes a substrate 11 and a fencing wall 12 formed on the substrate 11.

The substrate 11 is a flat board and includes a supporting surface 110 and a back surface 112. The supporting surface 110 is configured for supporting light sources (not illustrated) thereon; the light sources can be fixed on the supporting surface 110 through screwing or adhering. In the preferred embodiment, the light sources are LEDs mounted on a printed circuit board. The back surface 112 is opposite to the supporting surface 110 and away from light sources fixed on the supporting surface 110. The substrate 11 can be made of heat conductive materials, thereby assisting heat dissipation of the light sources. In this embodiment, the substrate 11 is an approximately rectangular board with four rounded corners.

The fencing wall 12 is formed on the supporting surface 110 of the substrate 11. The fencing wall 12 extends away from the supporting surface. The fencing wall 12 can be formed on fringe area of the supporting surface 110. Further, the fencing wall 12 can also form a closed circle and define a receiving space 13 for receiving the light sources. In this embodiment, the fencing wall 12 extends along a direction perpendicular to the supporting surface 110, and includes four periphery side surfaces 120, 122, 124, 126 connected end to end with four rounded corners at respective joints.

The side surface 120 has an elongated protrusion 121 formed thereon. The protrusion 121 protrudes outwardly and laterally away from the side surface 120 of the lamp holder 10 and extends along a direction parallel to the supporting surface 110. In this embodiment, the protrusion 121 protruding along a direction perpendicular to and away from the side surface 120, and has a profile increasing in size (i.e., height) along this extending direction. In a direction perpendicular to the side surface 120, the protrusion 121 includes a remote portion remote from the side surface 120 and an adjacent portion adjacent to the side surface 120. The remote portion of the protrusion 121 has a size larger than that of the adjacent portion of the protrusion 121. In other words, the protrusion 121 has a configuration of a tail of a dovetail joint.

The side surface 124 has a raised platform 1240 formed thereon. The platform 1240 protrudes away from the side surface 124 of the lamp holder 10. An elongated groove 125 is defined in the platform 1240. The groove 125 has an opening 1250 at an end thereof. The groove 125 has a shape matching that of the protrusion 121. In a direction perpendicular to the side surface 124, the groove 125 includes a top portion remote from the side surface 124 and a bottom portion adjacent to the side surface 124. The bottom portion of the groove 125 has a size larger than that of the top portion of the groove 125. In other words, the groove 125 has a configuration of a socket of the dovetail joint. The opening 1250 faces toward a front side of the lamp holder 10 as viewed from FIG. 2.

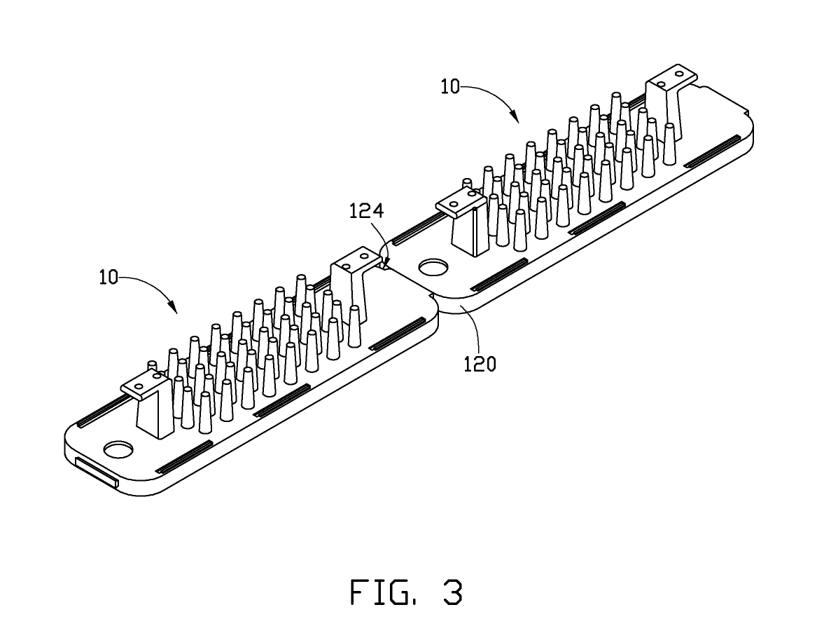

Referring to FIG. 3, the side surfaces 120 and 125 can be regarded as assembling surface of the lamp holders 10. The protrusion 121 of one lamp holder 10 can be inserted into the groove 125 of another lamp holder 10 via the opening 1250 of the groove 125. Due to that the protrusion 121 has a large size at top and a small size at bottom, and the groove 125 has a matched configuration, the protrusion 121 can be firmly held in the groove 125 without sliding out in a direction parallel to a longitudinal direction of the supporting surface 110 of the lamp holder 10.

Further, the back surface 112 of the substrate 11 can also have one or more fixing arm 1120 formed thereon. The fixing arm 1120 extends along a direction away from the back surface 112, and has at least one through hole 1122 formed on a distal end thereof. As such, screws can be utilized to fix lamp holder 10 to other lamp components, such as a frame, by extending the screws through the through hole 1122 to screw into the frame.

Still further, the back surface 112 of the substrate 11 can also have a plurality of heat dissipating rods 1124 formed thereon. The heat dissipating rods 1124 each extend away from the back surface 112 and have a cross section decreasing in size along a direction away from the back surface 112. That is, the heat dissipating rods 1124 each can have a shape of a truncated cone as shown in FIG. 3 or a truncated pyramid, and bottom surfaces of the heat dissipating rods 1124 are in contact with the back surface 112.

It is to be said that, the protrusion 121 and groove 125 are not limited to be formed on the two opposite side surfaces 120 and 124. The protrusion 121 and groove 125 can also be formed on the other two opposite side surfaces 122, 126.

It is to be understood that the above-described embodiments are intended to illustrate rather than limit the disclosure. Variations may be made to the embodiments without departing from the spirit of the invention as claimed. The above-described embodiments illustrate the scope of the disclosure but do not restrict the scope of the disclosure.

What is claimed is:

1. A modularly expandable lamp holder configured for mounting light sources thereon, comprising:
a first assembling surface, the first assembling surface having an elongated protrusion formed thereon, the protrusion comprising a first portion adjacent to the first assembling surface and a second portion remote from the first assembling surface, the second portion having a size larger than that of the first portion; and
a second assembling surface opposite the first assembling surface, the second assembling surface defining an elongated groove therein, the groove having an opening at an end thereof, the groove having a configuration matching that of the protrusion, the groove having a bottom portion adjacent to the second assembling surface and a top portion remote from the second assembling surface, the bottom portion having a size larger than that of the top portion;
whereby the lamp holder can be mechanically assembled with another lamp holder having a same configuration as the lamp holder by an engagement of the protrusion into the groove of another lamp holder via the opening of the groove thereof.

2. The modularly expandable lamp holder according to claim 1, comprising a substrate and a fencing wall, the substrate comprising a supporting surface for supporting the light sources and a back surface opposite to the supporting surface, the fencing wall being formed on the supporting surface of the substrate and comprising two periphery side surfaces respectively forming the first and second assembling surfaces.

3. The modularly expandable lamp holder according to claim 2, wherein the fencing wall extends from the supporting surface and along a direction perpendicular to the supporting surface.

4. The modularly expandable lamp holder according to claim 2, wherein the fencing wall is formed on a fringe area of the supporting surface.

5. The modularly expandable lamp holder according to claim 2, wherein the first and second assembling surfaces are at two longitudinally opposite ends of the substrate.

6. The modularly expandable lamp holder according to claim 2, wherein the first and second assembling surfaces are at two latitudinally opposite sides of the substrate.

7. The modularly expandable lamp holder according to claim 2, wherein the fencing wall comprises a plurality of raised walls connected end to end and forming a closed circle.

8. The modularly expandable lamp holder according to claim 2, wherein the protrusion protrudes along a direction parallel to the supporting surface.

9. The modularly expandable lamp holder according to claim 2, wherein the second assembling surface has a raised platform formed thereon and the groove is formed in the raised platform.

10. The modularly expandable lamp holder according to claim 2, further comprising a fixing arm formed on the back surface, the fixing arm extending along a direction away from the back surface and comprising at least one through hole formed on a distal end thereof.

11. The modularly expandable lamp holder according to claim 2, wherein the lamp holder is made of heat conductive material, and the lamp holder has a plurality of heat dissipating pins formed on the back surface and extending along a direction away from the supporting surface.

12. A lamp holder module comprising:
at least two lamp holders assembled together, each lamp holder being configured for mounting a plurality of light sources thereon, each lamp holder having a first assembling surface and a second assembling surface opposite the first assembling surface;
the first assembling surface having an elongated protrusion formed thereon, the protrusion comprising a first portion adjacent to the first assembling surface and a second portion remote from the first assembling surface, the second portion having a size larger than that of the first portion; and
the second assembling surface defining an elongated groove therein, the groove having a configuration matching that of the protrusion, the groove having a bottom portion adjacent to the second assembling surface and a top portion remote from the second assembling surface, the bottom portion having a size larger than that of the top portion;
wherein the at least two lamp holders are mechanically assembled with each other by an engagement of the protrusion of one lamp holder in the groove of the other lamp holder.
